(19) United States
(12) Patent Application Publication
(10) Pub. No.: US 2017/0128960 A1
(43) Pub. Date: May 11, 2017

(54) Programmable Shower Head

(71) Applicants: Richard S. D'Urso, Pacific Palisades, CA (US); Pauline A. D'Urso, Pacific Palisades, CA (US)

(72) Inventors: Richard S. D'Urso, Pacific Palisades, CA (US); Pauline A. D'Urso, Pacific Palisades, CA (US)

(21) Appl. No.: 15/210,191

(22) Filed: Jul. 14, 2016

Related U.S. Application Data
(60) Provisional application No. 62/251,246, filed on Nov. 5, 2015.

(51) Int. Cl. B05B 1/18; B05B 12/02; B05B 1/30

(52) U.S. Cl. CPC B05B 1/185; B05B 1/30; B05B 12/02

(57) ABSTRACT

The Programmable Shower Head has a shower head that replaces any existing standard shower head and a Control Panel that can be mounted anywhere on the shower wall. The shower head is a unique design utilizing a plurality of solenoid valves to direct water flow to a plurality of spray hole arrays. The Programmable Shower Head can be programmed to automatically adjust shower spray and shower duration during different shower cycles. The Programmable Shower Head can also be programmed to pause shower spray based on a sensor input. Customized programs for multiple individuals can be set-up prior to the shower from a Smart phone and run from the Control Panel at shower time. Program set-ups can be easily updated so each individual can train to shorten shower time and lower water use at their own pace.

### CROSS-REFERENCE TO RELATED APPLICATIONS

Provisional Patent Application No. 62/251,246, Programmable Shower Head, 5 Nov. 2015

### FEDERALLY SPONSORED RESEARCH OR DEVELOPMENT

This invention was not made by an agency of the United States Government or under a contract with an agency of the United States Government.

### REFERENCE TO SEQUENCING LISTING, A TABLE, OR A COMPUTER PROGRAM LISTING COMPACT DISC APPENDIX

Not Applicable

### BACKGROUND OF THE INVENTION

The purpose of this invention is to conserve shower water in a personal hygiene shower by programming the shower head to automatically adjust shower spray and shower duration during different shower cycles.

Significant water is wasted in showers due to continuous heavy water spray during the entire shower. If the shower spray is adjusted to levels appropriate for different shower cycles (such as pre-soak, applying soap, shampooing, rinsing, etc.), a significant amount of water can be saved. It is inconvenient and inefficient to manually adjust the shower spray for each cycle. A programmed adjustment of the shower spray and duration for different shower cycles would make this easy to accomplish.

Water is also wasted due to lengthy showers. If the length of the shower can be shortened, additional water can be saved. This is also a difficult goal to accomplish without a method to help individuals train to lower shower duration. A process of pacing the lowering of shower cycle length by monitoring and adjusting durations over time would help individuals achieve and maintain reduced shower durations.

### BRIEF SUMMARY OF THE INVENTION

The Programmable Shower Head has a shower head that replaces any existing standard shower head and a Control Panel that can be mounted anywhere on the shower wall. The shower head is a design utilizing a plurality of solenoid valves to direct water flow to a plurality of spray hole arrays. The spray hole arrays can be configured in a plurality of configurations including but not limited to circle, straight-line, grouped, or random patterns. The Programmable Shower Head can be programmed to automatically adjust shower spray (number of spray holes open) and shower duration during different shower cycles. The Programmable Shower Head can also be programmed to pause shower spray based on a sensor input. Customized programs for multiple individuals can be set-up prior to the shower from a Smart phone and run from the Control Panel at shower time. Program set-ups can be easily updated so each individual can train to shorten shower time and lower water use at their own pace.

### BRIEF DESCRIPTION OF THE SEVERAL VIEWS OF THE DRAWING

There are numerous embodiments of the Programmable Shower Head. The shape of the front of the shower head can be rounded, rectangular or square. The processor and control hardware can be embedded in the shower head or designed into a Control Panel. The program can be run from the control panel, the shower head, a Smartphone, a PC/tablet, or a mix of approaches. Communication to the shower head can be hardwired to a Control Panel, Blue Tooth wireless, Wi-Fi, or a combination of approaches. Indications of shower spray switching can include a short interruption in spray, an audio alarm, or a light indicator. Battery recharging can be electrical or solar. Having described these various embodiments of the invention, other changes and modifications can be made thereto without departing from the spirit or scope of the invention. Variations in decoration, substitution, combination, manufacturing, or simplification are also possible within the scope of this invention. The preferred embodiment of the Programmable Shower Head is shown in the following Figures.

FIG. 1: Programmable Shower Head—Preferred Embodiment Full View. This drawing shows the top-level design of the preferred embodiment of this invention.

FIGS. 2 a & b: Programmable Shower Head—Preferred Embodiment Programmable Shower Head Views. These drawings show the aspects of the remaining drawings.

FIG. 3: Programmable Shower Head—Preferred Embodiment Shower Head Front View. This drawing shows the shower head design from the front.

FIG. 4: Programmable Shower Head—Preferred Embodiment Shower Head Side Cutaway View. This drawing shows a cutaway view of the shower head design from either side.

FIG. 5: Programmable Shower Head—Preferred Embodiment Shower Head Top and Bottom Cutaway View. This drawing shows a cutaway view of the shower head design from the top and bottom.

FIG. 6: Programmable Shower Head—Preferred Embodiment Shower Head Back Cutaway View. This drawing shows a cutaway view of the shower head design from the back of the front face.

FIG. 7: Programmable Shower Head—Preferred Embodiment Control Panel Front Exterior View. This drawing shows an exterior view of the Control Panel design from the front.

FIG. 8: Programmable Shower Head—Preferred Embodiment Control Panel Front Cutaway View. This drawing shows a cutaway view of the Control Panel design from the front.

FIG. 9: Programmable Shower Head—Preferred Embodiment Functional Flow. This drawing shows the concept of operation of the preferred embodiment of this invention.

### DETAILED DESCRIPTION OF THE INVENTION

The following drawings depict the preferred embodiment of this invention. This invention is capable of other embodiments and is not limited by this embodiment.

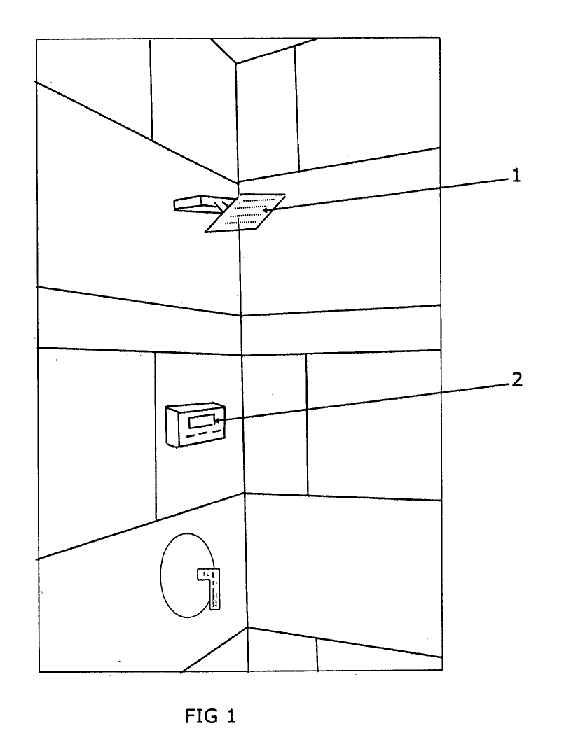

FIG. 1: Programmable Shower Head—Preferred Embodiment Full View—The preferred embodiment of the Programmable Showerhead consists of a (1) Shower Head with a square front and a (2) Control Panel. The Shower head fits in place of any standard existing shower head and the Control Panel can be hung anywhere in the shower.

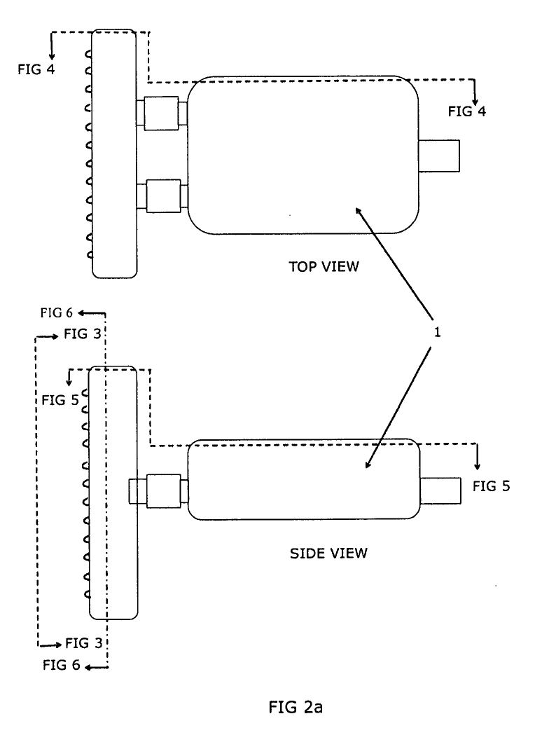

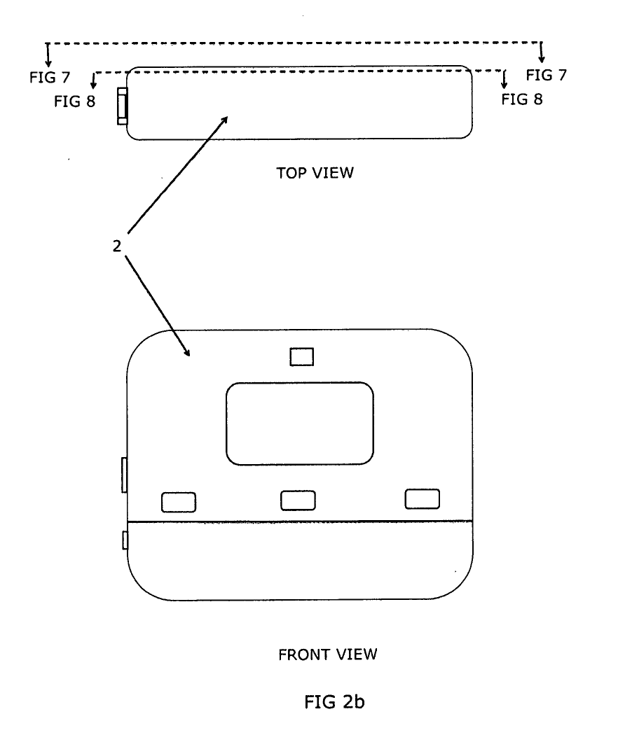

FIGS. 2 a & b: Programmable Shower Head—Preferred Embodiment Programmable Shower Head Views—The aspects of the following drawings are shown.

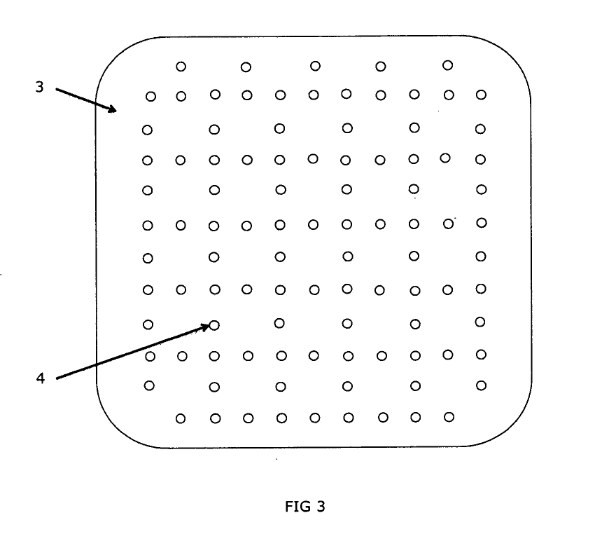

FIG. 3: Programmable Shower Head—Preferred Embodiment Shower Head Front Face View—The preferred embodiment of the Programmable Shower Head consists of a square (3) Shower Head Front Face and round (4) Spray Holes. The number, size, and exact placement of the spray holes are variable.

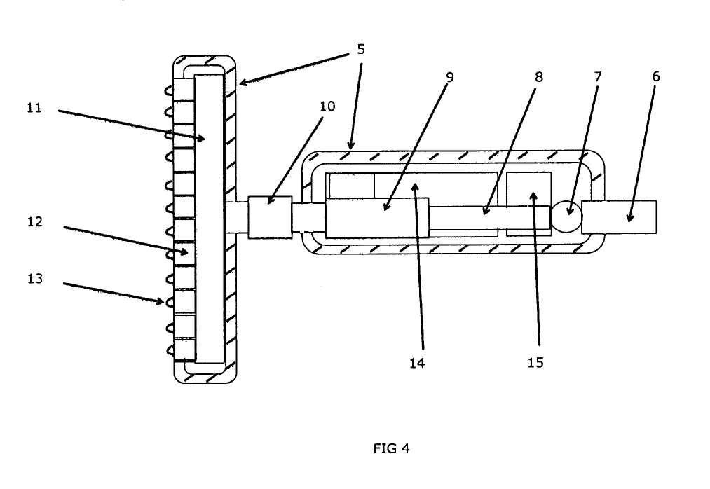

FIG. 4: Programmable Shower Head—Preferred Embodiment Shower Head Side Cutaway View—The preferred embodiment of the Programmable Showerhead consists of the (5) Enclosure connected to the water feed from the shower wall thru the (6) Tubing with flow restrictor and into a (7) Tubing Splitter. From there the water is directed to two (8) Tubes and to two (9) Solenoid Valves. The Solenoid Valves are electrically controlled from the (2) Control Panel to the (15) Bluetooth and Switching Electronics. The water will go thru two (10) Swivel Joints to the (11) Tubing connecting to the (12) Tubing Arrays where it will exit thru the (13) Spray Holes.

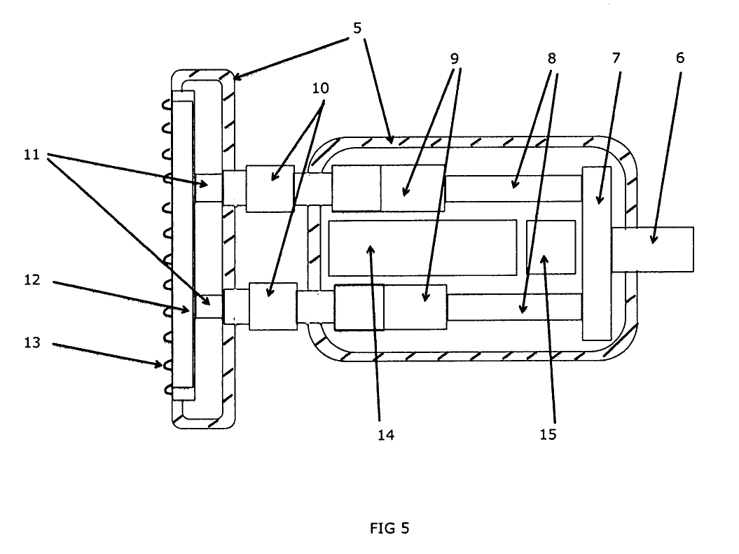

FIG. 5: Programmable Shower Head—Preferred Embodiment Shower Head Top and Bottom Cutaway View—This drawing shows the same components as the Side Cutaway View looking from the top. It shows the alignment of the components in the shower head to the (5) Shower Head Enclosure.

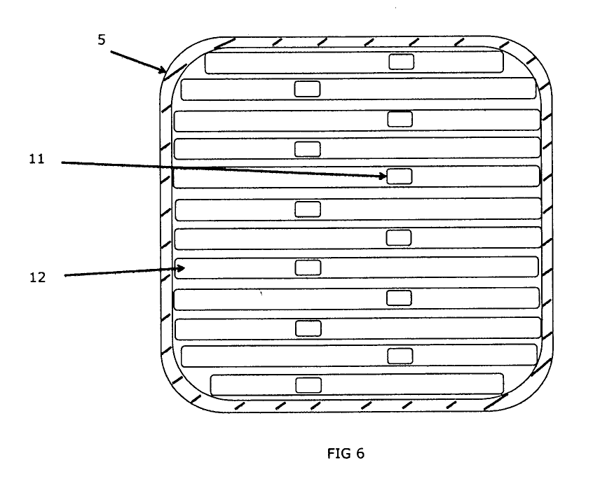

FIG. 6: Programmable Shower Head—Preferred Embodiment Shower Head Back Cutaway View—This drawing is a view of the (3) Shower Head Front Face looking from the back. It shows the alignment of (11) Tubing connecting to the (12) Tubing Arrays.

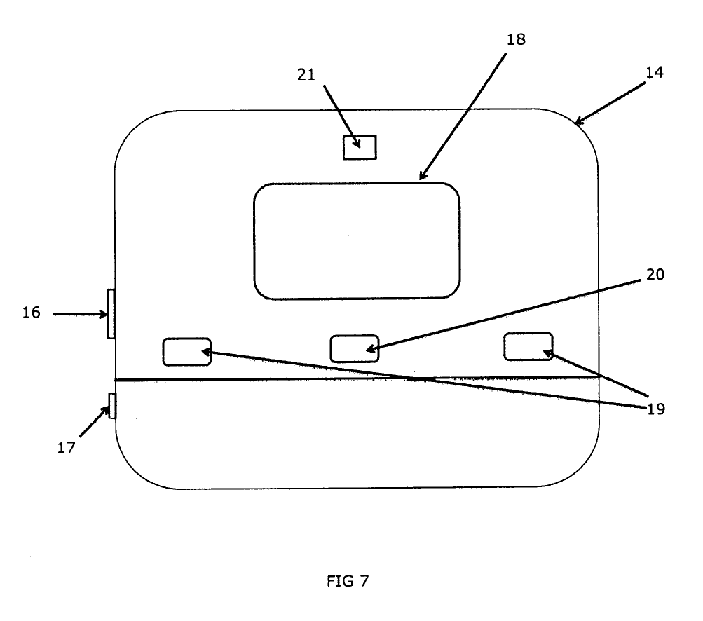

FIG. 7: Programmable Shower Head—Preferred Embodiment Control Panel Exterior Front View—The Control Panel can be fixed anywhere on the shower wall. Mounted to the (14) Control Panel Enclosure are an (16) On/Off Switch, a (17) Battery Recharge Connector, a (18) Digital Display, (19) Up/Down Buttons, an (20) Enter Button, and a (21) Sensor (Ultrasonic Range Finder).

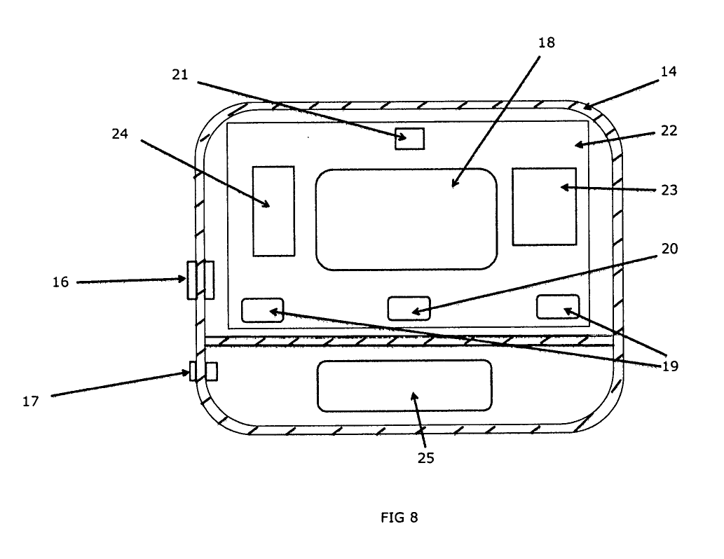

FIG. 8: Programmable Shower Head—Preferred Embodiment Control Panel Front Cutaway View—The electronics in the Control Panel are mounted on a (22) Circuit Board. The (23) Processor and Memory run the shower head program that controls the (15) Electronic Switches that connect the (14) Battery to the (9) Solenoid Valves thru the (15)/(24) Bluetooth transmitter/receiver electronics. The (16) On/Off Switch controls battery power to the electronics. A low voltage (25) Battery is included for the Control Panel electronics. The (18) Digital Display and the (19) Up/Down and (20) Enter Buttons are used to program and control the (23) Processor and Memory. A (21) Sensor (Ultrasonic Range Finder) is used to detect the presence of an individual user to turn on/off the (9) Solenoid Valves. The (24) Bluetooth Transmitter/Receiver also provides communication to a remote Bluetooth device to program the processor.

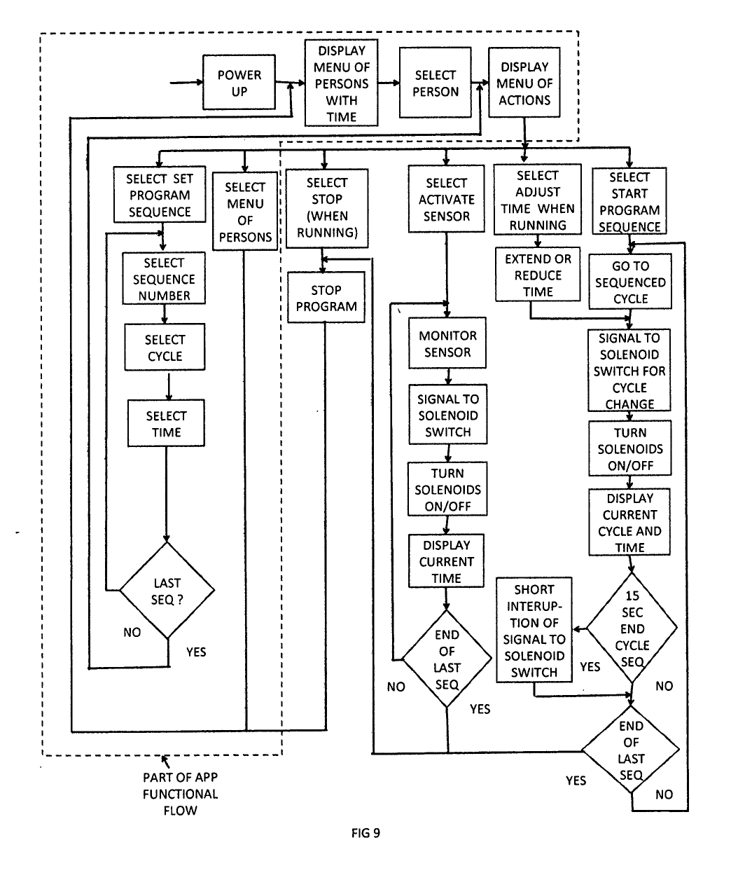

FIG. 9: Programmable Shower Head—Preferred Embodiment Functional Flow—This functional flow chart is a basic conceptualization of the operation of the Programmable Shower Head. The program can be customized for multiple individuals and can be saved prior to the shower and selected at shower time. The program can be easily updated so each individual can train to shorten shower time and lower water use at their own pace. The program can also be locked to control unauthorized changes to the shower program. Variations in the Display Menus, variations in sequencing actions and cycle definitions, differences in user interface approaches, and substitution, combination or simplification of the operation of the Programmable Shower Head are also possible within the scope of this invention.

When the power is turned on, a “Menu of Persons” is displayed with shower time. Using the Up/Down Buttons and Enter Button, an individual can select one of the listed names with overall shower time duration. A “Menu of Actions” will be displayed. The “Menu of Actions” includes as a minimum the following: “Set Program Sequence”, “Start Program”, “Adjust Time”, “Activate Sensor”, “Stop”, “Menu of Persons”. The “Menu of Persons” and “Set Program Sequences” processes are also available as an App on a Bluetooth device (smart phone). This allows shower set-up to be done outside the shower. A plurality of unique sequences of shower cycles and cycle times can be programmed. The shower cycles, as a minimum, are defined as: “Pre Soak”, “Apply Soap”, “Rinse Soap”, “Apply Shampoo”, “Rise Shampoo”, “Apply Conditioner”, “Rinse Conditioner”, “Shave”, “Rinse Shave”, and “Full Body Rinse”. After “Start Program Sequence” is selected, the firmware/software sequences the selected Spray Option (High, Medium, Low, Off) for each Shower Cycle, and controls the Switch to turn on power to the proper Solenoid Valve. The firmware/software also controls the Switch to turn on/off power to the Solenoid Valves and pause/resume the program in response to the Ultrasonic Range Finder. The firmware/software enables each individual user to extend or decrease Cycle Time during run time if desired. A short interruption in the Spray Cycle will automatically occur to notify the individual of upcoming Cycle change. The number of individual programs with customized Sequences, and, the definition and number of the Spray Cycles are user selectable.

### SEQUENCE LISTING

Not Applicable

1. The Programmable Shower Head is designed to conserve shower water in a personal hygiene shower by programming the shower head to automatically adjust shower spray and shower duration during different shower cycles.

2. The Programmable Shower Head of claim 1, wherein the Programmable Shower Head has a shower head that replaces any existing standard shower head and a Control Panel that can be mounted on the shower wall.

3. The Programmable Shower Head of claim 2, wherein the shower head is designed utilizing a plurality of solenoid valves to direct water flow to a plurality of spray hole arrays.

4. The Programmable Shower Head of claim 3, wherein the preferred embodiment of the shower head consists of:
The (5) Enclosure connected to the water feed from the shower wall thru the (6) Tubing with flow restrictor and into a (7) Tubing Splitter.
From there the water is directed to two (8) Tubes and to two (9) Solenoid Valves.
The Solenoid Valves are electrically controlled from the (2) Control Panel to the (15) Bluetooth and Switching Electronics.
The water will go thru two (10) Swivel Joints to the (11) Tubing connecting to the (12) Tubing Arrays where it will exit thru the (13) Spray Holes.

5. The Programmable Shower Head of claim 3, wherein the shape of the front of the shower head can be rounded, rectangular or square.

6. The Programmable Shower Head of claim 3, wherein the spray hole arrays can be configured in a plurality of configurations including, but not limited, to circle, straight-line, grouped, or random patterns, and, the number, size, and exact placement of the spray holes are variable.

7. The Programmable Shower Head of claim 2, wherein the control panel is programmed to automatically adjust shower spray (number of spray holes open) and shower duration during different shower cycles.

8. The Programmable Shower Head of claim 7, wherein mounted to the preferred embodiment of (14) Control Panel Enclosure are an (16) On/Off Switch, a (17) Battery Recharge Connector, a (18) Digital Display, (19) Up/Down Buttons, an (20) Enter Button, and a (21) Sensor (Ultrasonic Range Finder).

9. The Programmable Shower Head of claim 7, wherein the electronics in the preferred embodiment of the control panel are mounted on a (22) Circuit Board.
The (23) Processor and Memory run the shower head program that controls the (15) Electronic Switches that connect the (14) Battery to the (9) Solenoid Valves thru the (15)/(24) Bluetooth transmitter/receiver electronics.
The (16) On/Off Switch controls battery power to the electronics.
A low voltage (25) Battery is included for the Control Panel electronics.
The (18) Digital Display and the (19) Up/Down and (20) Enter Buttons are used to program and control the (23) Processor and Memory.
A (21) Sensor (Ultrasonic Range Finder) is used to detect the presence of an individual user to turn on/off the (9) Solenoid Valves.
The (24) Bluetooth Transmitter/Receiver also provides communication to a remote Bluetooth device to program the processor.

10. The Programmable Shower Head of claim 7, wherein the control panel processor and its control hardware can be embedded in the shower head or designed into the Control Panel.

11. The Programmable Shower Head of claim 7, wherein the control panel program can be run from the control panel, the shower head, a Smartphone, a PC/tablet, or a mix of approaches.

12. The Programmable Shower Head of claim 7, wherein the control panel communication to the shower head can be hardwired to a Control Panel, Bluetooth wireless, Wi-Fi, or a combination of approaches.

13. The Programmable Shower Head of claim 2, wherein having described these various embodiments of the invention, other changes and modifications can be made thereto without departing from the spirit or scope of the invention and variations in decoration, substitution, combination, manufacturing, or simplification are also possible within the scope of this invention.

14. The Programmable Shower Head of claim 1, wherein the concept of operation of the Programmable Shower Head is implemented in the hardware and software/firmware.

15. The Programmable Shower Head of claim 14, wherein the program can be customized for multiple individuals and can be saved prior to the shower and selected at shower time.

16. The Programmable Shower Head of claim 14, wherein the Programmable Shower Head's program can be easily updated so each individual can train to shorten shower time and lower water use at their own pace.

17. The Programmable Shower Head of claim 14, wherein the preferred embodiment of the operation is as follows:
When the power is turned on, a “Menu of Persons” is displayed with shower time.
Using the UP/Down Buttons and Enter Button, an individual can select one of the listed names.
A “Menu of Actions” will be displayed.
The “Menu of Actions” includes as a minimum the following: “Set Program Sequence”, “Start Program”, “Adjust Time”, “Activate Sensor”, “Stop”, “Menu of Persons”.
The “Menu of Persons” and “Set Program Sequences” processes are also available as an App on a Blue Tooth device (smart phone).
This allows shower set-up to be done outside the shower.
A plurality of unique sequences of shower cycles and cycle times can be programmed.
The shower cycles, as a minimum, are defined as: “Pre Soak”, “Apply Soap”, “Rinse Soap”, “Apply Shampoo”, “Rise Shampoo”, “Apply Conditioner”, “Rinse Conditioner”, “Shave”, “Rinse Shave”, and “Full Body Rinse”.
After “Start Program Sequence” is selected, the firmware/software sequences the selected Spray Option (High, Medium, Low, Off) for each Shower Cycle, and controls the Switch to turn on power to the proper Solenoid Valve.
The firmware/software also controls the Switch to turn on/off power to the Solenoid Valves and pause/resume the program in response to the Ultrasonic Range Finder.
The firmware/software enables each individual user to extend or decrease Cycle Time during run time if desired.
A short interruption in the Spray Cycle will automatically occur to notify the individual of upcoming Cycle change.
The number of individual programs with customized Sequences, and, the definition and number of the Spray Cycles are user selectable.

18. The Programmable Shower Head of claim 14, wherein the program can be locked to control unauthorized changes to the shower program.

19. The Programmable Shower Head of claim 14, wherein the control panel indications of shower spray switching can include a short interruption in spray, an audio alarm, or a light indicator.

20. The Programmable Shower Head of claim 14, wherein the basic conceptualization of the operation of the Programmable Shower Head may have variations in the Display Menus, variations in sequencing actions and cycle definitions, differences in user interface approaches and substitution, combination, or simplification of the operation are also possible within the scope of this invention.
